(19) United States
(12) Patent Application Publication
(10) Pub. No.: US 2022/0395872 A1
(43) Pub. Date: Dec. 15, 2022

(54) METHOD AND SYSTEM OF CLEANING SUBMERGED STRUCTURES

(71) Applicant: U.S. SUBMERGENT TECHNOLOGIES, LLC, Sarasota, FL (US)

(72) Inventors: Denver STUTLER, JR., Sarasota, FL (US); Dana AUSTIN, Jacksonville, FL (US)

(21) Appl. No.: 17/772,729

(22) PCT Filed: Jun. 4, 2021
(86) PCT No.: PCT/US2021/035939

§ 371 Date: Apr. 28, 2022

Related U.S. Application Data
(60) Provisional application No. 62/704,956, filed on Jun. 4, 2020.
(60) Provisional application No. 63/126,679, filed on Dec. 17, 2020.

(51) Int. Cl. B08B 9/08; B08B 9/46; B08B 9/093; B08B 13/00

(52) U.S. Cl. CPC B08B 9/0856; B08B 9/46; B08B 9/0933; B08B 13/00; B08B 2209/08

(57) ABSTRACT

The present invention relates generally to a method to determine one or more properties in a water storage facility and/or a water treatment facility. In one embodiment, the present invention relates to a method to determine one or more chemical and/or physical properties in a water storage facility vessel and/or a water treatment facility vessel and then use such one or more chemical and/or physical properties to determine where, if need be, any sand or other sediment needs to be removed from any such water storage facility vessels and/or a water treatment facility vessels.

### CROSS REFERENCE TO RELATED APPLICATIONS

This application claims priority to U.S. Provisional Patent Application No. 62/704,956 entitled “Cleaning of Submerged Structures Utilizing Precise Geo-Mapping and Remote Guidance of Cleaning Equipment” filed on Jun. 4, 2020 and U.S. Provisional Patent Application No. 63/126,679 entitled “Cleaning of Submerged Structures Utilizing Precise Geo Mapping and Remote Guidance of Cleaning Equipment” filed on Dec. 17, 2020, each of which are hereby incorporated by reference in their entirety.

### FIELD OF THE INVENTION

The present invention relates generally to a method and system of determining one or more properties in a water storage facility and/or a water treatment facility as well as the submerged cleaning of waste collection system structures such as, but not limited to, sewers, sumps, wet wells, collection tanks, digesters, clarifiers, classifiers, and the like. The present invention further relates to a methodology and processes for determining the location of submerged sediment and the volume within the tank or other submerged structure.

### BACKGROUND

Water treatment facilities (e.g., water purification plants, sewage treatment plants, and the like) typically use one or more submerged water storage vessels and/or treatment vessels during the process of treating sewage and/or purifying water. While such water storage vessels and/or treatment vessels at these facilities can be of any shape or size, an exemplary unit may include an oval-shaped and above-ground concrete tank that is squared off at one end. The facility may treat sewage using both anaerobic and aerobic processes within the same tank, with anaerobic processes predominating at one end, and aerobic processes predominating in the channels and at the opposite end. The tank may be approximately 200 feet long and 60 feet wide.

As may be known to those having ordinary skill in the art, water storage and/or treatment structures, such as tanks or vessels, storm water and other pipes, culverts, and the like, may periodically need to have debris, grit, sand and/or sediment removed from them in order to continue to operate at a desired efficiency level. Accumulation of debris, grit, sand and/or sediment in these structures may affect the design capacity and treatment efficacy of the structure or system. Such debris, grit, sand and/or sediment can enter the structures through the collection system of pipes and lift stations. Any grit or sand that is not removed in the pre-treatment areas may eventually settle at the bottom of the structures and become sediment (for the purposes herein, these terms may be used interchangeably and sediment includes any debris, grit, or sand that may accumulate or exist in the system). As sediment accumulates, the volume and distribution of the sediment increases and may begin to effect the system. For example, the effectiveness of the treatment process may be compromised due to loss of volume in the structures and changes in waste water flow patterns and retention time due to the accumulation of sediment.

Prior to cleaning the structures, an estimate of the accumulated sediment volume may be made to estimate several factors including time needed to clean, costs associated with the cleaning process, and the volume of sediment that must be removed. Estimates desirably occur while the structures are submerged, thus allowing the structures and system to remain in service. To date, the amount, volume, and/or location of sediment removal is generally based on inadequate and imprecise estimation measures, including estimates based on experience and estimation methods including rod probing in accessible locations along vessel walls and cat walks. None of these measures, singularly or in combination, yield precise sediment volume measurements or provide meaningful data on sediment volume distribution.

As a result, most often, the sediment cleaning processes require draining of the structures intended to be cleaned to expose and visually quantify the accumulated sediment for subsequent removal. This methodology, while exposing and perhaps enabling sufficient cleaning of the drained structures, may not be ideal, however, as the structures, and sometimes the whole system, must be removed from service while these structures are drained and cleaned. Further, any undrained structures in the system would remain uncleaned or result in blind and inefficient cleaning if cleaned while still submerged. Treatment facilities with limited treatment capacity may not be able to drain, clean, and remove a structure from service, even temporarily, without disrupting their entire service to their service area.

For this reason, sediment removal while the tank remains submerged and operational may be preferred. Submerged cleaning, however, much like submerged estimation, can be inefficient, costly, and time-consuming as the precise location and volume of the sediment cannot been seen or otherwise accurately determined in the high turbidity water. As a result, cleaning of the structures while submerged is generally done blindly, without much data, and therefore is mostly governed by sheer luck as to whether such removal is actually effective. Alternatively, other methods of submerged cleaning may include lowering a hose into the undrained structure, conducting a “sweep” of the entire structure floor, and suctioning the sediment and water into a collection tank to ensure maximum recovery of capacity and efficiency of the system. In some cases, a submersible pump may be placed on the hose to increase collection efficiency. As the precise distribution of the sediment in the structure is unknown, the entire structure bottom must be “swept” with the hose to ensure all the sediment is removed. This methodology is inefficient and costly because it does not target areas of the structure that could most benefit from and that actually require cleaning.

As may be known to those having ordinary skill in the art, the distribution of grit in a structure is rarely uniform across the bottom. Rather, the sediment accumulates in the physical form of hills, mounts, and reefs, and is subject to the hydrodynamics of the waste water flow within the structure and the system and the physical characteristics of the sand, grit, and sediment entering the structures and system. These realities of structure cleaning result in an inefficient removal process, that is unduly time consuming and expensive to the facility or that is ineffective and does not fully remove a desired or sufficient amount of sediment to operate at a desired capacity, efficiency, or for a desired length of time before the sediment accumulates and cleaning is required again

The amount of waste sediment that may be generated using current cleaning processes cannot be accurate estimated due to the fact that an accurate in situ volume and density of the sediment cannot be measured and thus is no empirical factor to calculate dry weight mass of waste from in-situ sediment volume. This results in unexpected disposal costs for the facility if the waste is underestimated and uncertainty that the cleaning was sufficient if the amount of waste was underestimated, which cannot be readily determined.

As a result, it is currently not possible to efficiently and economically clean accumulated sediment from structures such as wastewater treatment tanks and vessels, storm water and other pipes, culverts, and the like, while the structure is filled.

Accordingly, there is a need in the art for an improved method by which to determine where and to what extent sediment has accumulated at the bottom of water storage facility structures and/or water treatment structures, such as the tanks and vessels therein. Further, there is a need in the art for a method and system of cleaning sediment out of water storage facility structures and/or water treatment structures, such as the tanks and vessels therein, while the structure is filled, without having to drain the vessel, remove it from its submerged location, or temporarily remove it from service.

### SUMMARY

The present invention relates generally to methods, processes, and systems of determining one or more properties in a water storage facility and/or a water treatment facility as well as the submerged estimation and/or cleaning of waste collection systems such as sewers, sumps, wet wells, collection tanks, digesters, clarifiers, classifiers, and the like, and components and structures thereof. In one embodiment, the present invention relates to a method to determine one or more chemical and/or physical properties in a water storage facility vessel and/or a water treatment facility vessel and then use such one or more chemical and/or physical properties to determine where, if need be, any sediment is to be removed from any such water storage facility vessels and/or a water treatment facility vessels.

The present invention relates generally to a sequence of methods, processes, and systems that determine precise elevation mapping of the sediment on the floor of a submerged structure, that provide accurate estimates of sediment volume within a filled tank, that remotely guide the cleaning equipment within the tank, and that estimate the amount of waste that will be generated, thereby reducing the time and effort required to clean the tank

In one embodiment, the method of the present invention relates to a method to determine where and/or to what extent sediment and/or sand needs to be removed from a water storage facility vessel and/or a water treatment vessel.

In one embodiment, the method of the present invention relates to a method that uses data relating to one or more of water temperature, salinity, dissolved oxygen, pH, oxidation reduction potential and/or turbidity in a water storage facility vessel and/or a water treatment vessel to determine where and/or to what extent sediment and/or sand needs to be removed from such a water storage facility vessel and/or a water treatment vessel.

In one embodiment, the method and system of the present invention relates to a method of cleaning a vessel without removing it from its submerged location. Further, the method includes generating a post-cleaning survey including a mapping of sediment elevation and a removed sediment volume calculation.

Disclosed is a method for 3-dimensional mapping of sediment located in a submerged structure of a water storage or treatment facility and targeted cleaning of the sediment. The method may include one or more of (and in any order): conducting a pre-cleaning evaluation of the structure; performing pre-cleaning data collection or surveying of the structure; mapping the pre-cleaning sediment elevation of the structure; calculating the pre-cleaning sentiment volumes and weight in the structure; and removing sediment from the structure.

In an embodiment, the service of the water storage or treatment facility may not be interrupted or paused. In an embodiment, the method may further comprise conducting a post-cleaning evaluation of the structure. In an embodiment, the post-cleaning evaluation of the structure may comprise performing post-cleaning data collection or surveying of the structure. In an embodiment, the method may further comprise comparing the pre-cleaning data collection or surveying of the structure with the post-cleaning data collection or surveying of the structure. In an embodiment, the post-cleaning evaluation of the structure may comprise mapping the post-cleaning sediment elevation of the structure. In an embodiment, the method may comprise comparing the pre-cleaning mapping the sediment elevation of the structure with the post-cleaning mapping the sediment elevation of the structure. In an embodiment, the post-cleaning evaluation of the structure may comprise post-cleaning calculation of sentiment volumes and weight in the structure.

In an embodiment, the method may further comprise comparing the pre-cleaning calculation of sentiment volumes and weight in the structure with the post-cleaning calculation of sentiment volumes and weight in the structure. In an embodiment, the method may further comprise comparing the pre-cleaning calculation of sentiment volumes and weight in the structure with the amount of sediment removed from the structure during cleaning. In an embodiment, the pre-cleaning evaluation of the structure may include determining suitability of the structure for mapping and cleaning. In an embodiment, the pre-cleaning data collection may include measuring and analysis of water chemistry. In an embodiment, the pre-cleaning calculation of sentiment volumes and weight in the structure may be determined by overlaying the mapped sediment elevation of the structure onto a scaled drawing of the structure. In an embodiment, removing sediment from the structure may further include using a GPS to guide cleaning equipment to remove sentiment based on the mapping the sediment elevation of the structure. In an embodiment, the method may further comprise collecting and analyzing samples of the pre-cleaning sediment. In an embodiment, data from one or more of water temperature, salinity, dissolved oxygen, pH, oxidation reduction potential and turbidity in the structure may be used to determine where or to what extent to remove the sediment. It is noted that any of these described steps may be implemented in any order and combination departing from the scope of the present invention.

Disclosed is a method for mapping and cleaning sediment in a submerged structure of a water storage or treatment facility. In an embodiment, the method may comprise one or more of (and in any order): identifying a suitable structure; conducting a pre-survey site inspection; collecting water chemistry data; analyzing the water chemistry data; conducting a pre-cleaning acoustic survey; mapping the sediment elevation; creating a floor sediment elevation map; collecting sediment samples; analyzing the sediment samples; generating a sediment report; calculating sediment volumes and weight; cleaning the structure; separating grit from water; conducting a post-cleaning acoustic survey; re-mapping the sediment elevation; calculating the volume of removed sediment; and generating a tank cleaning report.

In an embodiment, the pre-cleaning acoustic survey and the post-cleaning acoustic survey may be compared in the tank cleaning report to determine sufficiency of cleaning. In an embodiment, the mapping the sediment elevation and the re-mapping the sediment elevation may be compared in the tank cleaning report to determine sufficiency of cleaning. In an embodiment, the calculated sediment volumes and weight and the calculated volume of removed sediment may be compared in the tank cleaning report to determine sufficiency of cleaning.

### DESCRIPTION OF THE DRAWINGS

Operation of the present teachings may be better understood by reference to the detailed description taken in connection with the following illustrations. These appended drawings form part of this specification, and written information in the drawings should be treated as part of this disclosure. In the drawings:

FIG. 1 is a flow chart showing an embodiment of a method and process of mapping and removing sediment in a submerged structure as described herein;

FIG. 2 is an aerial view of an example of a viewable portion of a water treatment facility showing a water storage and/or treatment tank that may be mapped and cleaned as described herein;

FIG. 3 is a graph detailing turbidity data from turbidity stations 1-3 T;

FIG. 4 is a graph detailing turbidity data from turbidity stations 4-6 T;

FIG. 5 is a graph detailing turbidity data from turbidity stations 7-9 T;

FIG. 6 is a graph detailing redox potential data from stations 1-3 T;

FIG. 7 is a graph detailing redox potential data from stations 4-6 T;

FIG. 8 is a graph detailing redox potential data from stations 7-9 T;

FIG. 9 is a graph detailing dissolved oxygen data from stations 1-3 T;

FIG. 10 is a graph detailing dissolved oxygen data from stations 4-6 T;

FIG. 11 is a graph detailing dissolved oxygen data from stations 7-9 T;

FIG. 12 is a map showing an exemplary quantity survey of an oxidation ditch of the tank located at the Ma shown in FIG. 2;

FIG. 13 is an exemplary topography map of a floor of a tank such as the tank shown in FIG. 2;

FIG. 14 is a cross-section of the topography map of FIG. 13;

FIG. 15 is a view of an embodiment of an apparatus wherein a submersible pump/vacuum system is utilized to pump the waste slurry into the waste container; and

FIG. 16 is a view of an embodiment of an apparatus wherein a vacuuming system/submersible pump is utilized to move the waste slurry into the waste container.

### DESCRIPTION OF THE INVENTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As noted herein, the present invention relates generally to a method to determine one or more properties in a water storage facility and/or a water treatment facility. In one embodiment, the present invention relates to a method to determine one or more chemical and/or physical properties in a water storage facility vessel and/or a water treatment facility vessel and then use such one or more chemical and/or physical properties to determine where, if need be, any sand or other sediment is to be removed from any such water storage facility vessels and/or a water treatment facility vessels.

In one embodiment, the method of the present invention relates to a method to determine where and/or to what extent sediment and/or sand needs to be removed from a water storage facility vessel and/or a water treatment vessel.

In one embodiment, the method of the present invention relates to a method that uses data relating to one or more of water temperature, salinity, dissolved oxygen, pH, oxidation reduction potential and/or turbidity in a water storage facility vessel and/or a water treatment vessel to determine where and/or to what extent sediment and/or sand needs to be removed from such a water storage facility vessel and/or a water treatment vessel.

In one embodiment, the method of the present invention relates to a method of creating a 3-dimensional model of accumulated debris, sediment, grit, etc. within a submerged tank. The method may include using GPS and other mapping technology to create the 3-dimensional model.

The present invention allows for the estimation and calculation of the amount of waste sediment that is in the area to be cleaned more accurately than current processes. The present invention is able to measure and calculate a more accurate in situ volume and density of the sediment to use as empirical factors to calculate dry weight mass of waste from in-situ sediment volume. As a result, estimated/actual disposal costs and estimated/actual waste removal are also more accurate than when using current methods. For example, in many cases the removal of waste from a structure, such as a waste tank or the like is charged by the amount of waste material removed from such structure. The present invention allows for a more accurate calculation of the material to be removed, which provides a more accurate quote at the onset of the project. This can help the owner/manager of the structure know the price in advance and secure the appropriate funding/approval.

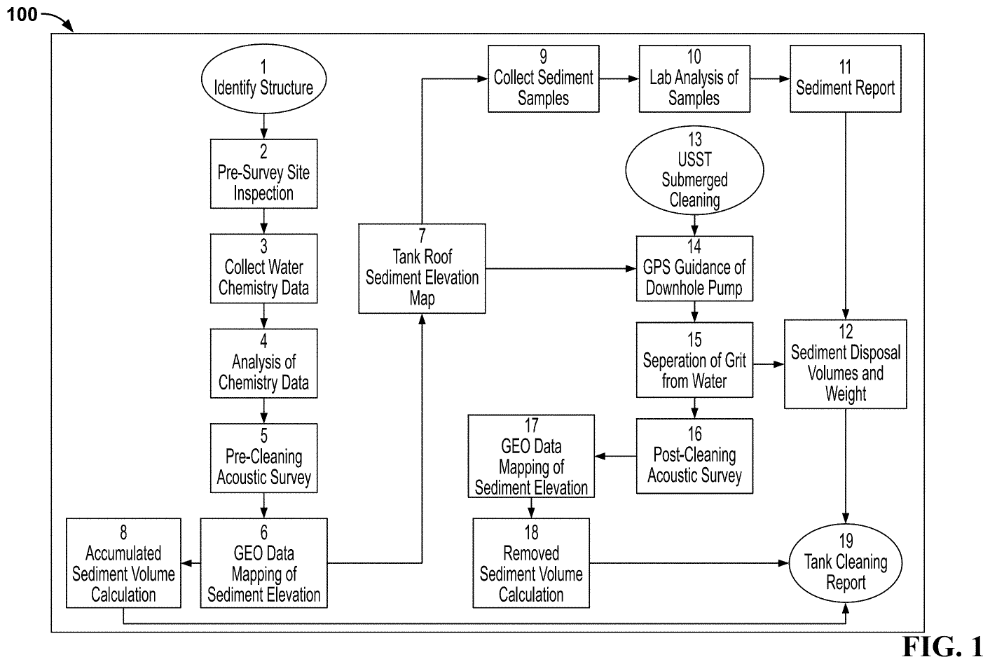

FIG. 1 is a flow chart of a method or process 100 of mapping and removing sediment in a submerged structure. Generally speaking, the method 100 may include one or more of: (1) identifying the structure(s) to be cleaned; (2) conducting a pre-survey site inspection as described herein; (3) collecting water chemistry data of various types described herein; (4) analyzing the chemistry data to help make determinations regarding next steps; (5) pre-cleaning acoustic survey; (6) conducting GEO data mapping of sediment elevation; (7) determining tank floor sediment elevation map; (8) determining accumulated sediment volume calculation; (9) collecting sediment samples; (10) analyzing the samples; (11) completing and reviewing sediment report; (12) determining intended sediment disposal volumes and weight; (13) submerged cleaning; (14) using GPS guidance for the downhole pump or vacuum device; (15) separating sediment from water; (16) conducting a post-cleaning acoustic survey; (17) conducting GEO data mapping of sediment elevation; (18) determining removed sediment volume calculation; and (19) completing and reviewing tank cleaning report based on comparing intended sediment disposal volumes and weight and removed sediment volume.

In an embodiment, the method 100 includes each of the above-listed steps in the above-listed order. It is noted that one or more of the above-listed steps may also be combined, reordered, excluded, etc. without departing from the disclosed method. It is also noted that the method 100 may be split into separate processes that may be completed at different times or in different phases or that may be used as a separate method entirely, including pre-cleaning surveys which can include evaluation of the water facility and system, evaluation and mapping of sedimentation; determination or calculation of desired sedimentation to be removed; removal of sedimentation, and post-cleaning survey which may can include reevaluation and re-mapping of sedimentation or comparison of actual sedimentation removed and desired sedimentation to be removed. In other words, the evaluation components of the above-listed steps may be performed separate and apart from the cleaning steps described. In fact, a different entity may perform the evaluation steps from the entity that performs the cleaning.

In an embodiment, the method 100 may combine several processes and methodologies in a specific sequence. The method 100 may, in a mapping stage, generate and utilize a 3-dimensional model of the accumulated debris within the structure. The method 100 may, in a cleaning stage, remotely guide the cleaning equipment using GPS and the generated 3-dimensional map. For example, from the 3-dimensional model, the exact, near exact, or approximate volume of accumulated sediment in a structure can be calculated, and its location within the tank determined. Using GPS to guide the submerged cleaning equipment in the structure, only those areas with significant accumulations of sediment or that are desired to be cleaned may be cleaned and the progress monitored by comparing how much sediment is removed from an area to the calculation of how much sediment was in the area. This selective and intentional cleaning may both reduce the time required for cleaning and the cost to the facility, and may also ensure sufficient cleaning of the structure for increased efficiency and capacity of the system. Also, a more precise estimate of the amount of the sediment can be made prior to cleaning the structure to better estimate disposal costs. Further still, knowing the location of the sediment can help the party conducting the cleaning pick the most appropriate cleaning apparatus to conduct the cleaning. My way of a non-limiting example, if the sediment is in a location that is a way from the side of the structure being cleaned, the entity cleaning the structure may choose to use a combination downhole pump/vacuum truck with a dripless tube that is expandable a distance. An example is disclosed in U.S. Pat. No. 9,796,003, which is incorporated herein by reference.

The method 100 includes identification of a suitable structure 1 to which the invention can be successfully applied. Suitable structures may include, but are not limited to, storage or treatment tanks, vessels, or basins, pumping systems, screening, separation, or filtration chambers, clarifiers, digesters, aeration systems, treatment, disinfectant, and additive chambers, storm water and other pipes within the storage or treatment system, culverts, drainage areas, and the like. Suitable structures may also include any kind of holding device that includes a liquid or liquids, solid or solids and/or biosolid or biosolids. The structure to which the present teachings can be applied isn't limited to just those described herein. Any kind of holding device that possesses any of the foregoing attributes may be a suitable structure hereunder. For various reasons, such as not having access to critical areas of the tank to take measurements, not all submerged structures may be appropriate for the process and methodology of mapping and cleaning. The method and identification of a suitable structure 1 may further include application of criterion the has been developed to rank a suitability of a potential structure using aerial or satellite images, which can be performed without having conduct a physical site visit, or may include conducting a physical site visit. When reviewing aerial or satellite images or conducting a physical site visit, the potential structures should be evaluated by criterion which includes accessibility of equipment and rolling stock, water depth, height of tank walls above ground level, location of catwalks and railings, and the like, to determine suitability of the various structures for mapping and cleaning. Suitable qualities of structures for mapping and cleaning include, for example areas with greater accessibilities, areas known to have more accumulated sediment, areas known to be generally representative of the composition in the tanks, and the like. Unsuitable qualities of structures for mapping and cleaning may include, for example those that don't have any liquid or don't have enough solids or biosolids to clean. It should be noted, however, that a suitable structure may also include a cover or top and isn't limited to the open tank shown in the drawings.

Once a suitable structure is identified, a pre-survey site inspection 2 may be conducted to confirm the suitability determination and identify any potential problems that may arise during cleaning. For example, the pre-survey site inspection 2 can be used to determine one or more of access, dimensions for sizing and spacing sonar imaging, water quality, solids sampling, and the like. The pre-survey site inspection may comprise collection 3 of and analysis 4 of various water chemistry measurements as described below to assess sediment in the structure. For example, one or more or the following measurements and analyses of the water in the structure may be used: temperature, pH, salinity, oxidation-reduction potential, turbidity, and the like. Additionally, a pre-cleaning acoustic survey 5 may be conducted via various methods, equipment, processes, and analyses. The pre-cleaning acoustic survey may be performed using specialized commercial equipment and may comprise acoustic surveying equipment, remote-controlled surface vessels, software and data processing devices, and the like. Chemistry analysis may also provide specific insight as to the relationship between water chemistry and acoustic survey measurements. For example, chemistry analysis may provide insight as to the relationship between turbidity and sonar range. The chemistry analyses may include one or more of salinity, temperature measurements, pH, oxidation reduction potential (which if too low may suggest anaerobic process and the production of undesirable nitrogen gas that can interfere with the processes of the facility and/or could negatively impact the ability to measure the material in the structure), oxygen levels, turbidity, and the like. The turbidity level is important in that a high turbidity level can negatively impact the present system's ability to measure the amount of material in the structure. Knowing the turbidity can help determine the accuracy of the information or allow the user to adjust the system to account for the higher turbidity. The variation of each measurement going down predefined dimension (e.g., each foot of height from the surface) may provide insight into the discontinuity of layers in the tank as well as insight into the composition and layering of the sediment and biosolids, as well as the amount of each and the locations. The chemistry analyses may be carried out by lowering a probe through the waste water and to take point measurements and varying depths or take a continuous measurement at increasing depths. A chemistry analysis report may be generated and compared to past data to further understand the relationship between water chemistry and acoustic survey measurements. Other analyses may also include grain size analyses of the solids and/or biosolids found in the structure. Knowing the grain size can help determine the overall weight of the material in the structure that needs to be removed. This can help knowing how much material is to be removed and the total cost to the owner/manager of the facility to remove the material from the structure. Knowing the density of the material helps determine the weight, which is essential to knowing the cost of removing the material.

Following the above-described data collection, collected data may be processed, evaluated, analyzed, and mapped 6 using software so as to produce and transform the data into a 3-dimensional topographic image or tank floor elevation map 7 of the accumulated sediment in the structure and on the structure floor. The 3-dimensional topographic image or tank floor elevation map 7 may include elevation information related to the higher and lower accumulated sediment areas within the tank and may also be converted into a sonar map. The elevation information may include coloring, such as red for the highest elevations and blue for the lower elevations (and orange, yellow, green, etc. to indicate varying elevations in between) and these elevations can be used to target specific cleaning of sediment so that only the higher elevations are cleared. This can increase efficiency of the cleaning process and decrease the effort and time needed to complete requisite cleaning to get the tanks to a working capacity. This may also allow a user to more easily identify problem areas or areas with more solids/biosolids than other areas. This may help focusing the cleaning effort make the structure easier to clean with the analysis than otherwise. The aforementioned analysis may be conducted by a software program or app that takes the information data points assesses them and then outputs the information. The software program may be utilized in the non-transitory memory of any known computing device.

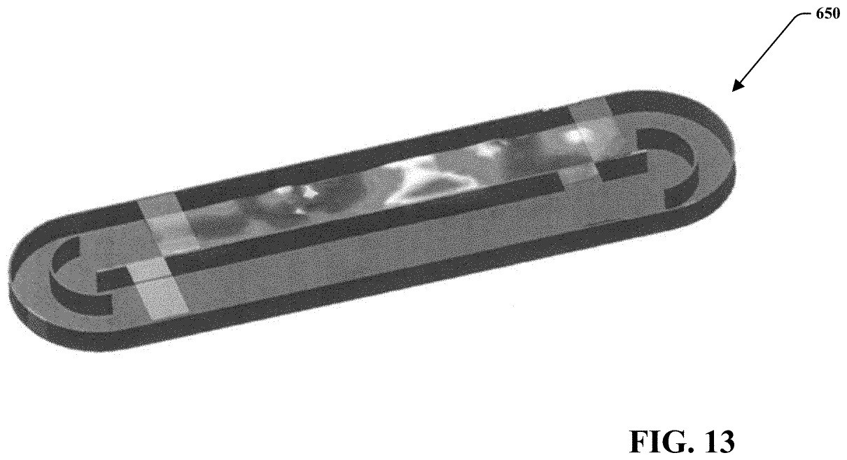

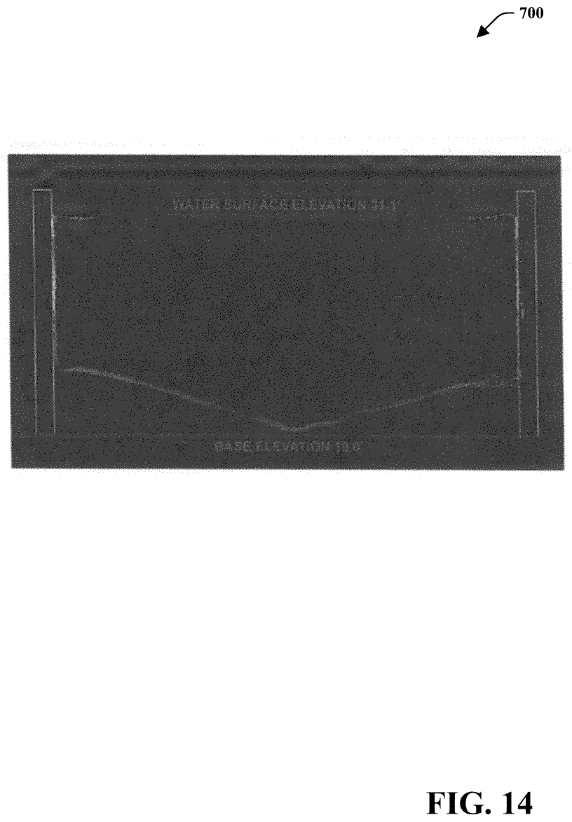

The chemistry analyses and/or elevations maps may also provide more accurate removal estimations compared to current measuring processes which often can be both much lower and much higher than the actual removal. An example 650 of the tank floor elevation map 7 is shown in FIG. 13 and a cross-sectional view 700 is shown in FIG. 14. This 3-dimensional topographic image or tank floor elevation map 7 may be then overlaid on an as-built scale drawing of the structure and an accumulated sediment volume calculation may be determined 8. As a result, the data collected from GEO mapping (also referred to as geographic(al) mapping or geographical information systems) may be used to produce a tank floor elevation map 7 and to determine an accumulated sediment volume calculation 8. The accumulated sediment volume calculation 8 may be determined by using software that computes the volume of the 3-dimensional information.

The tank floor elevation map 7 may then be used to determine locations of collecting sediment core samples 9. As an example, the sediment core samples 9 may be collected from areas identified through the tank floor elevation map 7 as having significant accumulation of sediment. Specialized equipment designed to remove intact sediment core samples from waste water tanks may be used to collect the sediment core samples 9. Such specialized core sampling equipment may include a “sludge judge” that has been modified to take an intact sediment sample. The sediment core samples 9 may then be filtered in the field to remove excess water, with the remaining sample stored on ice to preserve the sediment core samples 9 for analysis. The sediment core samples 9 may then be processed for further data analysis 10. In one aspect, the processed sediment core samples 9 may be taken to a quantitative analysis laboratory for analysis in accordance with a specific protocol. The analyses may include analyses for grain size distribution and other physical property characteristics. This information may assist with determining the in situ density and the resultant removed material to be disposed. Other analyses may include percent H₂O, percent organics, and percent inorganics. In another aspect, the processed sediment core samples 9 may be analyzed in the field using a portable lab brought to the site. The resulting data may include calculations for determining sediment density, percent volume, and mass of the inorganics and organics contained within the sediment. A sediment analysis report 11 may be generated and used to estimate the sediment disposal volumes and weights 12 after cleaning operations 13 occur. These volumes and weight may be particularly useful in understanding the materials and composition of the waste tank so as to target efficient cleaning. The sediment disposal volumes and weights 12 measured after cleaning operations 13 occur may indicate when sufficient or desired cleaning as been accomplished and the sufficient or desired sediment has been removed from the structure or that the desired sediment in a specific location has been removed.

Cleaning of the structure may be carried out using customized equipment designed to efficiently remove sediment from a submerged structure, such as a submersible pump. An example of which is described below. In an example, the cleaning operation may be precisely guided using a GPS transponder 14 in connection with the tank floor elevation map 7 so that the areas of the structure having significant accumulation of sediment are selectively targeted and cleaned. During the cleaning process, waste water and organic materials may be separated from the sediment using gravity separation and filtration equipment, or any other technique or process that is known or otherwise may become known in the art. The wastewater and organic materials, free of sediment, may then be returned to the structure for further processing. The collected solid sediment may then be dewatered to a “paint-filter” dry condition before disposal of such material. Disposal may be accomplished in a variety of manners including disposal on-site or via transport to a landfill. Prior to disposal, the volume and/or weights 12 of the solid sediment material is collected and recorded for further analysis.

Following cleaning of the structure and removal of the sediment, a post-cleaning acoustic survey may be conducted to verify that the measured loss of capacity has been restored in accordance with the agreed upon plan 18 with the facility. The accumulated sediment volumes 8, removed sediment volume calculations 18, and sediment disposal volumes and weights 12 may be utilized to prepare a final tank cleaning report 19.

Additionally, the acoustic reports and analyses described herein may also allow for the customer and facility specific estimations of future cleanings and provide a schedule based on when the facilities are expected to hit a 10% loss of capacity, which would interfere with the facility's functions. This may allow a facility to have a preventative maintenance schedule developed for it. This would prevent unnecessary cleaning of a structure that isn't in need of such, allows for only that portion of a structure that needs to be cleaned being cleaned or prevents a structure from reaching a level of undesired material rendering ineffective or inoperable. The system will allow an operator to sell this as a service to structure owner/manager. The owner/manager is able to use the system to know when this preventative maintenance is required to prevent their structures from becoming inoperative, presents conducting unneeded cleaning all of which can help the owner/manager save money and time.

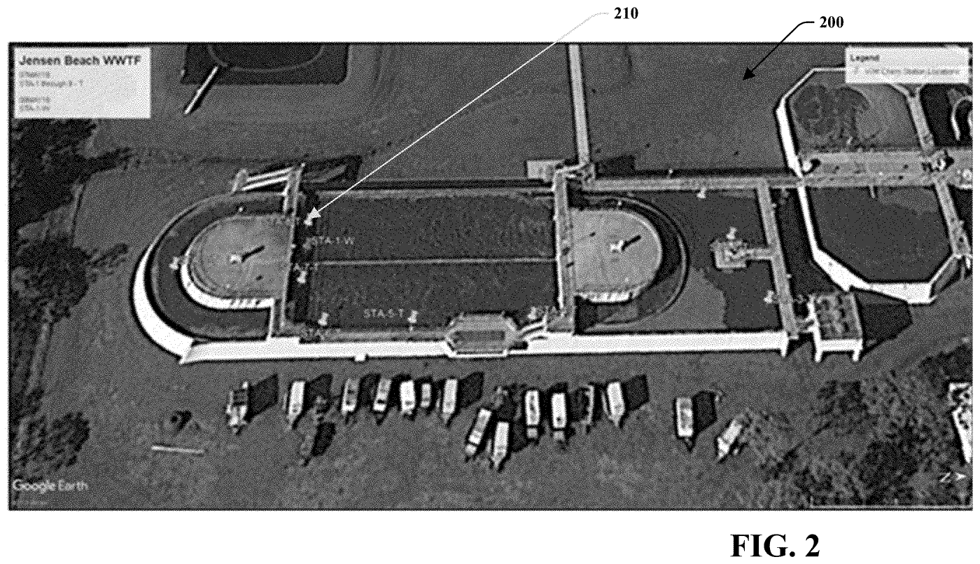

One example of how the method 100 of the present invention operates was conducted at an exemplary facility shown in FIG. 2. The facility is an oval-shaped above-ground concrete tank that is squared off at its northern end. The facility treats sewage using both anerobic and aerobic processes within the same tank, with anerobic processes predominating at the northern end, and aerobic processes in the channels and at the southern end. The tank is approximately 200 feet long and 60 feet wide.

Water Column Profiles: Water circulation and aeriation was shut down at 0900 so that a series of nine water column profiles 210 could be taken from various stations, for example, (1) from the northern end of the tank, (2) along the western channel wall, and (3) at the southern end of the tank (see FIG. 1). These sites were chose due to the ease in accessibility for these site-specific structures. However, the water column profiles 210 could have been taken from any location and from any amount of locations. The present teachings aren't limited to just these exemplary locations.

Measurements of pH, redox potential, salinity, turbidity and dissolved oxygen were taken at 1 foot intervals from the water surface to the bottom of the tank (or in some cases, to the top-of-the-sediment) at each of the nine stations 210 indicated in FIG. 1. It should be understood that the 1 foot interval is merely exemplary. Any appropriate interval may be chosen and may change such as based on the depth of the structure from which the sample is being taken.

Stations STA 1-3—T are in the anerobic basin area over the time from 0913 through 0946 (33 minutes). Stations STA 4-6—T are located along the west channel wall in an aerobic digestion area over the time from 0957 through 1022 (25 minutes). STA 7-10—T are in the southern turning basin, also aerobic, over the time from 1334 through 1356 (22 minutes).

Temperature and Salinity: Temperature and salinity are nearly uniform from the surface to the bottom at all stations during the sampling period, indicating the water column was well mixed without the development of either a thermocline or halocline.

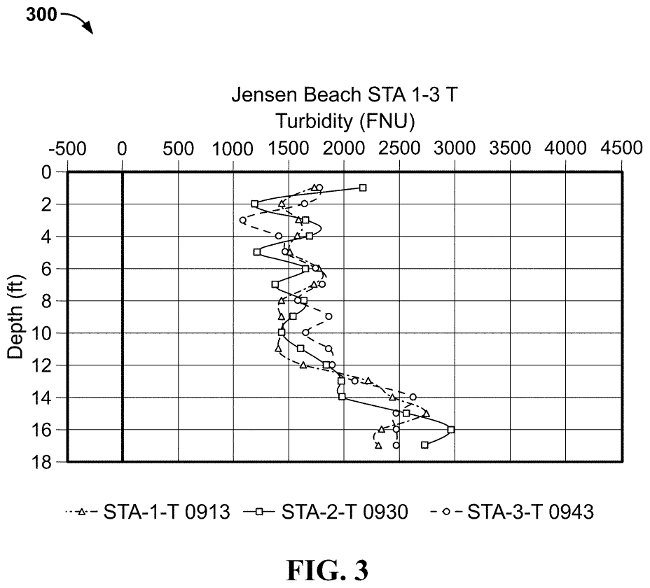

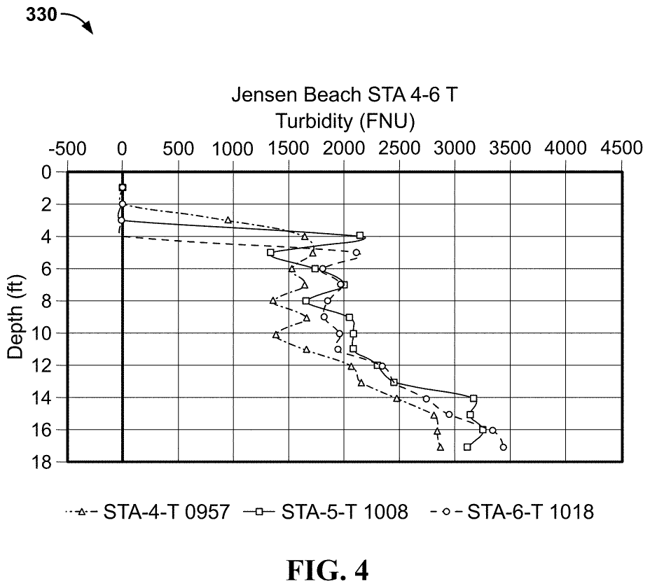

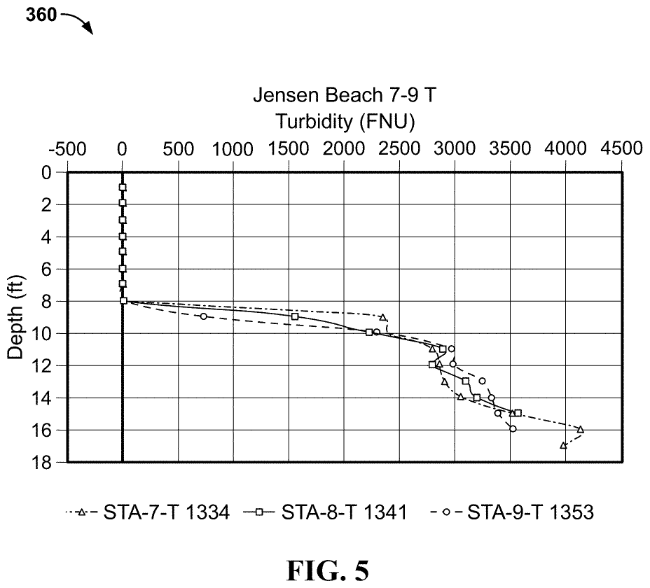

Turbidity: Turbidity measurements 300, 330, 360 showed high values (1,000 to 4,000 FNU) varying by depth and time from aeriation shut down (see FIGS. 3 through 5). Clearing of the upper water column is fairly rapid and dramatic, indicating the floc mass is well formed with a greater density than the water. Within four hours after aeriation shut down, the water is less than 1 FNU from the surface to 8 foot in depth. Turbidity levels in the lower water column increase over time indicating the settling rate of the floc is significantly slower in the upper water column. One explanation for this could be the formation of pin floc from the denitrification of nitrate to nitrogen gas, trapping bubbles in the floc increasing their buoyance. “Popping,” the phenomena of nitrogen bubbles breaking the surface scum is observed in this area at that time, providing visual confirmation of denitrification. By 1334 a very sharp turbidity dine forms at the depth of 8 foot to 10 foot where turbidity went from less than 1 to over 2,000 FNU.

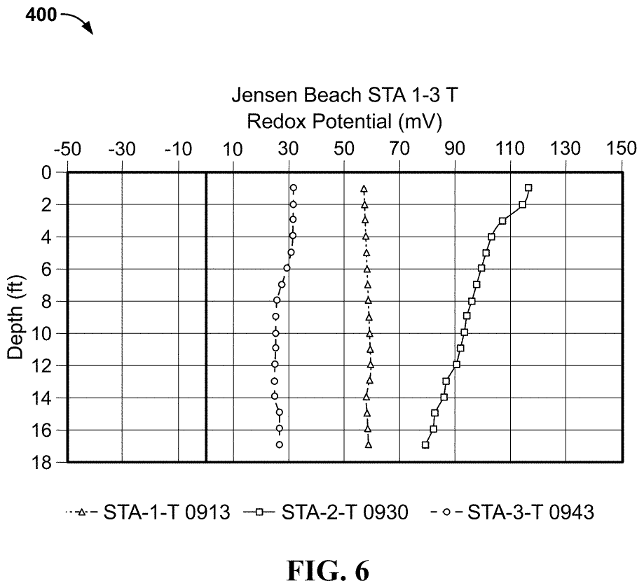

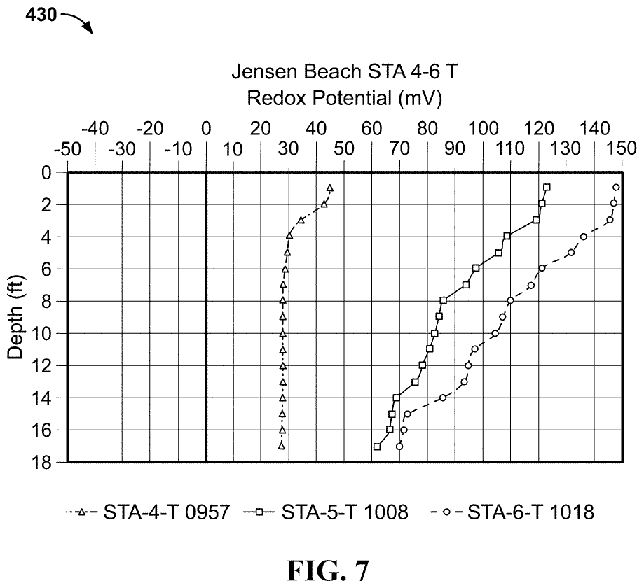

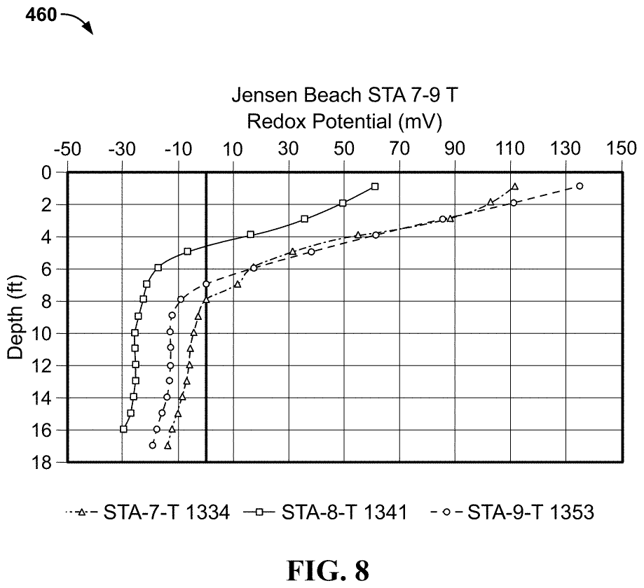

Redox Potential: Redox potential measurements 400, 430, 460 range from a high of approximately 150 mV to a low of −30 mV over all Stations (see FIGS. 6 through 8). In STA 1-3—T, from the anerobic area of the tank, the redox potential indicates bacterial processes are predominately cBOC degradation and denitrification. STA 4—T is also in identification, with STA 5-6—T primarily in nitrification. STA 7-9—T show the development of a strong redox dine at a depth of 6 to 8 feet below the surface. Bacterial processes went from strong nitrification in the surface waters, to robust denitrification in the deeper waters.

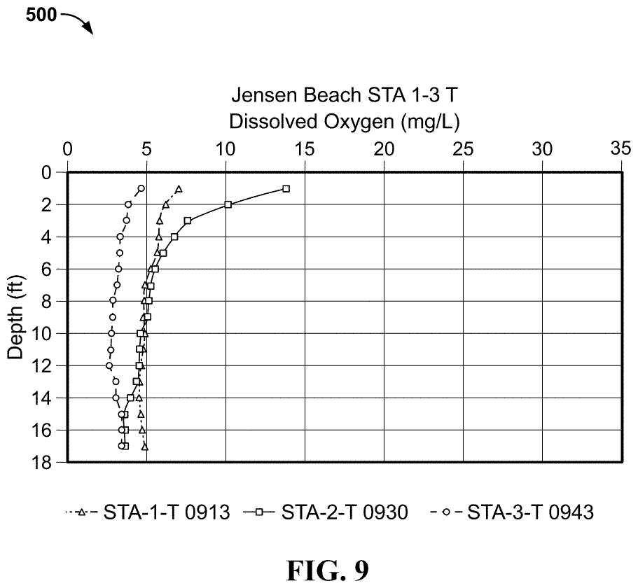

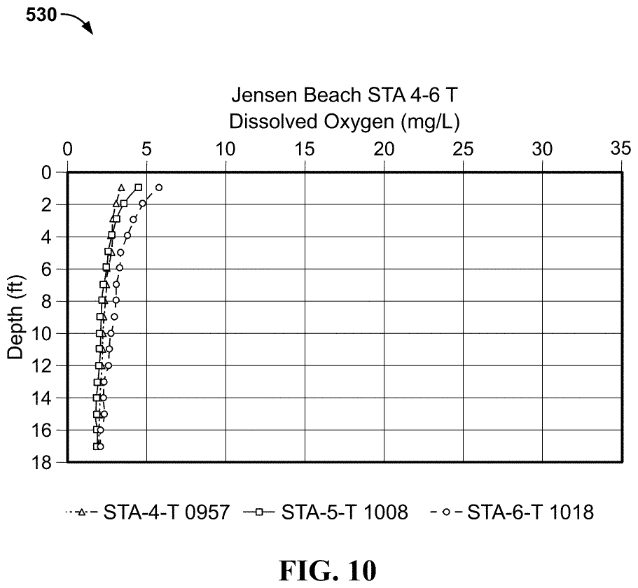

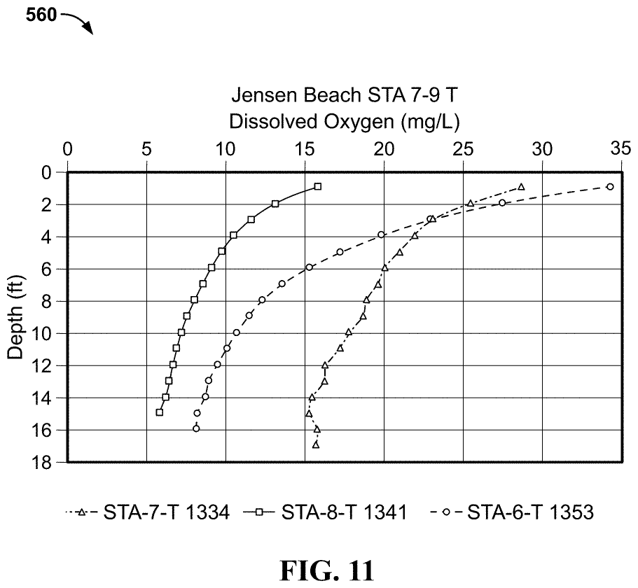

Dissolved Oxygen: Dissolved oxygen measurements 500 are relatively high in the anerobic area of the ditch (see FIG. 9) with values ranging from 10 to 3 mg/L from the surface to the bottom of the tank. Results 530 from STA 4-6—T (see FIG. 10) show similar high oxygen saturation levels. Oxygen levels 560 in the area of STA 7-9—T (see FIG. 11) show the water column is super-saturated with oxygen, particularly in the upper half of the water column.

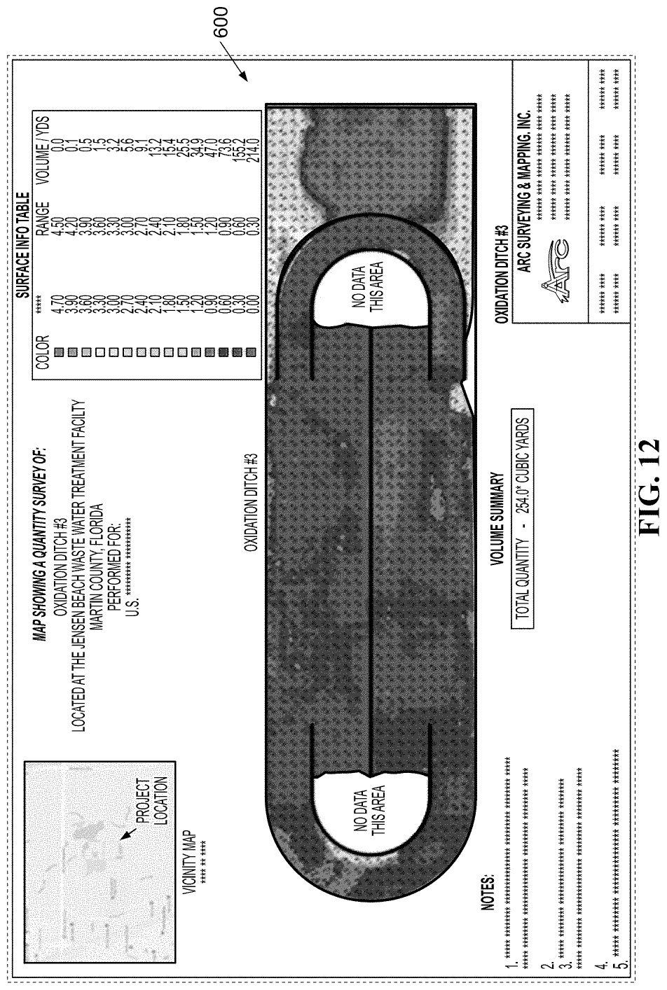

Sedivision Results: The geophysical survey is able to survey 600 approximately 90% of the Oxidation Ditch tank bottom (see FIG. 12). The tank bottom area beneath the two mixers at either ends of the tank could not be surveyed due to equipment limitations at the time of the survey. The survey of the oxidation ditch shows a loss of capacity of 251 cubic yards, with the largest accumulation being in the northern (anoxic) section of the tank. In this area the accumulation is highest along the western and eastern walls, with a high of 4.2 feet. The remaining area of the tank bottom sediment is fairly uniform, with the accumulation ranging from 0.1 to 1 foot. As a point of comparison, if the area surveyed had a uniform 1-foot accumulation the total accumulation would be 454 cubic yards. Percentage loss of capacity is calculated to be 3.64%. The geophysical survey may be conducted by any appropriate device. In a non-limiting example, an acoustic survey device may be utilized. One example of an acoustic survey device comprises using vector acoustic sensors. Another example is an energy source that is typically an array of different sized air-chambers, filled with compressed air. The source is releases bursts of high-pressure energy into the water. The returning sound waves are detected and recorded by hydrophones that are spaced out or a single hydrophone is utilized. In yet another example, a sonar device that is capable of generating a survey may be utilized. This may be similar to the technology used in other sonar devices, such as a fish finder and the like. It should be understood that these are merely exemplary acoustic survey devices and that any configuration of an acoustic survey device that is capable of operating in water or liquid can be utilized.

As noted above, the facility shown in FIG. 2 uses a combined anerobic/aerobic treatment process with pretreatment of the influent to remove large solids and sand. Water chemistry measurements indicate the treatment process is performing within good treatment specifications. Stable temperatures overtime indicates a uniform mixing of the water column. Oxidation Reduction Potential values provide a direct indication of the types of critical chemical processes occurring with the wastewater.

Turbidity measurements demonstrate rapid clearing of the upper half of the water column, beginning immediately after aeriation/circulation shut down, indicating swift sinking of the floc mass. Most interesting is the development of an extremely sharp turbidity dine at the 8 to 10 foot depth, concurrent with sharply increasing turbidity in the 10 to 17 foot depth. Normally this would be assumed to be associated with a water density discontinuity. However, uniform water column values of temperature and salinity (the two primary controllers of water density) demonstrate no such discontinuity existed. Therefore, in one non-limiting example, it can be concluded that while the upper layer floc is sinking into the lower half of the tank, the floc in the lower half remained suspended, or at least had a much lower sedimentation rate. The material from the rapidly sinking floc from the upper water column, combined with the slower sedimentation of the floc in the bottom half, results in the higher turbidity levels in the 10 to 17 foot depth range.

At the same time as the development of the turbidity dine, redox potentials in the same area are rapidity falling with depth, from relatively high positive values (strongly nitrifying conditions) to moderately low negative values (strongly denitrifying conditions). During denitrification, bacteria convert nitrate to nitrogen gas (N₂), forming nitrogen bubbles. If the bubbles are large enough to rise to the surface and break through the scum, “popping” will be observed. This phenomenon is observed in this area at the time of the measurements, confirming denitrification in the bottom waters was well underway at the time, as indicated by the chemical measurements that determined the concentration of dissolved oxygen in the waste water.

In previous wastewater tank surveys, and confirmed by this survey, that turbidity concentration was unrelated to SediVision or acoustic/sonar survey range in the tank. This leads to a conclusion that residual air bubbles (which are a strong attenuator of sonar signals) from the aeriation process (either bubblers or circulators) limited the sonar range. These bubbles would be expected to both rise to the surface and dissolve in the wastewater over time, gradually increasing the sonar range to see the floor and sidewalls of the tank. Previous studies did not completely bear this out, with sonar range being limited to about 25 foot in the best cases. While it is likely that air bubbles play an important role in limiting sonar range, it is clear other limiting factor(s) must also be in play.

The facility shown in FIG. 2 and results from the conducted experiments provide compelling evidence that nitrogen bubbles resulting from denitrification are an important factor in sonar range limitation in at least two ways. First, free rising nitrogen bubbling (popping) will increase over time as the denitrification process predominate in the lower portion of the tank and as measured by the decreasing redox potential. This will offset the reduction of air bubbles (from the aeriation/circulation process) by dissolution to maintain a more constant bubble concentration. Second, small nitrogen bubbles will enmesh in floating floc masses, increasing their buoyancy and reducing their settling rate. Overtime, one would expect a high concentration of micro-bubble laden floc suspended in the water column. As this applies to SediVision or acoustic/sonar survey range, one would expect to see increasing range as the air bubble dissolve, then the range obstructed (or possibly reduced) as nitrogen bubble concentrations increase. This information can be applied to the system to generate an acoustical/sonar survey that is more accurate than other versions because it can account for the various factors that previously degraded the quality. Accounting for these factors allows for a more accurate survey, which in turn allows for a more accurate location and calculation of the amount of sediment, solids, biosolids and the like in the structure. Knowing this will help removal thereof in a more efficient and cost effective manner.

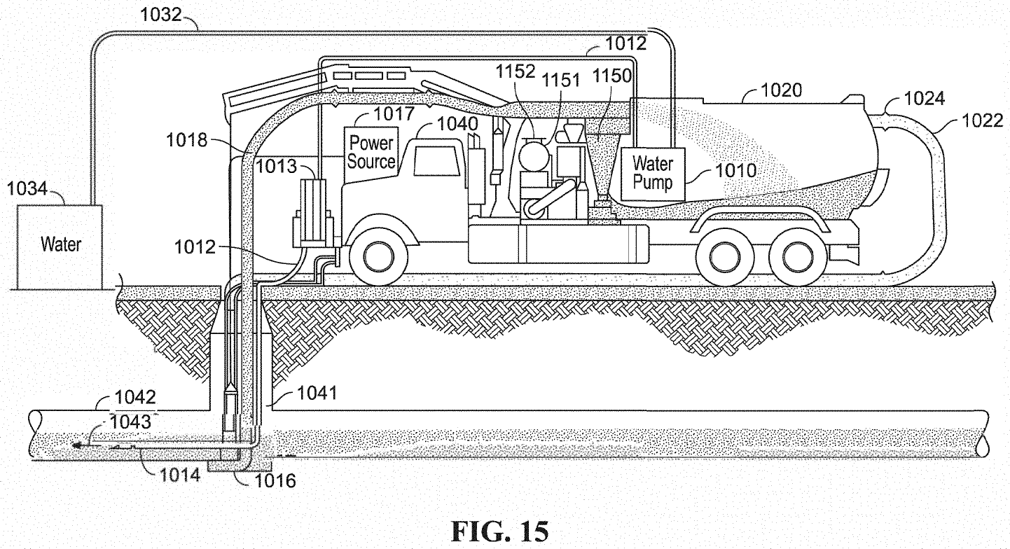

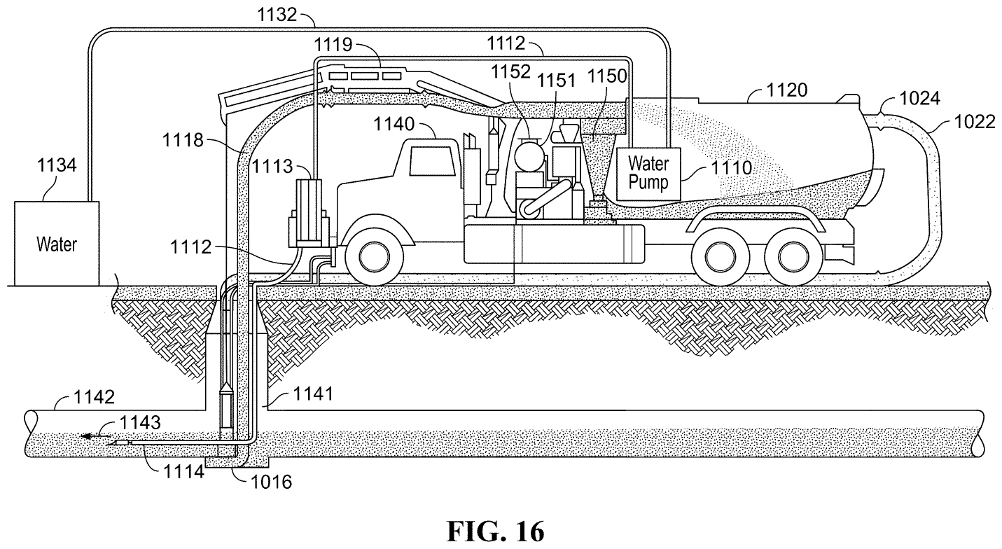

Referring now to FIGS. 15 and 16, the system of the present invention comprises a high pressure water pump assembly 1010 for generating high pressure water, a high pressure water hose 1012, a hose reel 1013, a cleaning head 1014 for receiving high pressure water and cleaning a sewer, a submersible pump 1016 for pumping a slurry of solids and liquids out of the sewer when the slurry contains a large amount of liquid, a power source 1017 for the submersible pump 1016, a slurry hose 1018, a waste container 1020 for receiving the pumped slurry, a decant water hose 1022, a decant water outlet 1024 for releasing the water from the container, main supply water line 1032, and main supply water source 1034. The invention may be mounted to a truck 1040 as seen in FIGS. 15 and 16, or to an immobile unit that must be towed to and from a jobsite. For consistency, the unit will be described as a truck throughout this document. It should be noted that while water is mentioned as the liquid in which the submersible pump 1016 operates, the present teachings are not limited to such. The submersible pump 1016 may operate in any kind of liquid.

The high pressure water pump assembly 1010 and pump power source 1017 are mounted on, for example, a truck 1040 and may use the truck engine for power. The purpose of the pump assembly 1010 is to pressurize water for use in washing sewer lines 1042 by means of cleaning head 1014 attached to and in communication with high pressure water hose 1012. The source of water for pump assembly 1010 may be derived from any water source 1034, including a fire hydrant, a tank on the truck 1040, or from the sewer 1042 itself. Further, the high pressure water pump assembly 1010 may be of any appropriate configuration and type. By way of a non-limiting example, the high pressure water pump assembly 1010 may be configured as a hydraulically driven down-hole (submersible) pump. While a single water pump assembly 1010 is shown and described, any number of water pump assembly 1010 may be utilized without departing from the present teachings, e.g., two, three, four, etc. In some embodiments, four water pump assemblies 1010 may be attached to a single truck.

The cleaning head 1014 may be bullet-shaped with a front and rear face. The rear face of the cleaning head 1014 may include water jet outlets 1015 directed backwardly. The truck 1040, high pressure water hose 1012 and cleaning head 1014 may be of any suitable conventional equipment. When the cleaning head 1014 is lowered through a manhole 1041, and into a sewer 1042, high pressure water, such as 2000 psi may be applied through the hose 1012 to the cleaning head 1014. The high pressure water applied to the cleaning head 1014 has several functions. First, the water sprays out of the outlets 1015 and the exiting high pressure water washes the solid material from the walls of the sewer 1042 and suspends the sewer pipe solid material in a slurry. Additionally, the high pressure water being applied to the cleaning head 1014 moves the cleaning head 1014 in a direction 1043. After cleaning the sewer 1042, the cleaning head 1014 may be retrieved by retracting the high pressure water hose 1012 by means of hose reel 1013.

If conditions dictate that a submersible pump 1016 should be used, i.e., if a relatively high volume of liquid exists in the sewer 1042, a submersible pump 1016 is provided with a capacity of more than the total flow of water being injected to the cleaning head 1014 as well as any normal sewer flow. It is desirable to have a large water content in the sewer 1042 for efficiently cleaning the sewer 1042 by suspending the solid particles and material in the sewer 1042 in a liquid slurry. The submersible pump 1016 is capable of pumping a slurry having up to 80% solids.

For example only, if the high pressure water pump provides a flow of 60 gallons per minute, a suitable submersible pump 1016 capable of removing 2000 gallons a minute of 80% solid material is desirable for allowing the present invention to clean an operating sewer having flowing fluids therein. While any suitable submersible pump 1016 may be provided, pump series 53, sold by Garner Environmental Services, Inc., is satisfactory. Such pumps can be powered hydraulically and powered by diesel, electric motors, gasoline engines or any other available power source. Additionally, a jetter type sewer pump is contemplated herein. In one embodiment, two jetter sewer pumps may be utilized having a rating of 180 GMP.

The fluidized slurry from the submersible pump 1016 may be transmitted through the slurry hose 1018 to a waste container 1020. The fluidized slurry enters the top of the container 1020, where the solids and water separate and the solids settle to the bottom of the container by gravity. If desired, baffles may be provided in the container 1020 to assist in the separation. The water is then decanted from the container 1020 and as the container 1020 fills up, the decanted water is released from the container 1020 by means of the positive pressure forcing the water through a decant water hose 1022. The waste container 1020 may be of any appropriate configuration and type. By way of a non-limiting example, the waste container 1020 may be pressurized as described in more detail below. While a single submersible pump 1016 is shown any described, any number of submersible pumps 1016 may be utilized, e.g., two, three, four, etc.

The waste container 1020 may be either permanently affixed to the truck 1040, or may be removable therefrom. If the waste container 1020 is removable, when the container 1020 is substantially filled up with solid particles, it may be removed and a replacement container 1020 may be rolled into place and connected to hoses 1018 and 1022. The filled container 1020 may then be removed to a dump site while the truck 1040 remains on site and continues the cleaning operation. If the waste container 1020 is permanently affixed to the truck 1040, the truck 1040 must go to the dump site each time the waste container 1020 becomes substantially filled up with solid materials. Further, still multiple waste containers 1020 may be utilized without departing from the present teachings. In such embodiments, the waste containers 1020 may be operatively attached with one another, such as in a series. In these embodiments, if one of the waste containers 1020 is filled with solid materials, the adjacent waste container 1020 may then become filled with the slurry as described above. If multiple waste containers 1020 are used, each of the waste containers 1020 may be continuously filled such that the pump 1016 need not stop running once one of the waste containers 1020 fills. Any appropriate tubing may be attached between the plurality of waste containers 1020.

When the submersible pump 1016 is used, the more water that flows through the cleaning head 1014 and sewer 1042 the better the cleaning operation. In the present system, the decanted water can be used to provide additional washing by injecting it upstream of the cleaning head 1014 and pump 1016. This allows keeping the solid materials in the sewer in suspension so that they can more easily be removed by the pump 1016. The decanted water is transmitted through decant water outlet 1024 to decant waterline 1022 and then to a manhole 1041 into the sewer 1042 upstream of the cleaning head 1014 for increasing the water in the sewer flow.

This additional water, applied to the sewer 1042 aids in more efficiently cleaning the sewer 1042, and the pump 1016 has the capacity to completely remove the water in the system. Thus, the present embodiment is in effect a closed loop and the decanted water, all water injected or decanted, is utilized in cleaning the upstream portion of the sewer. Furthermore, the water need not be disposed of by trucking. After the sewer 1042 is cleaned, the cleaned decanted water may be disposed of in the sewer 1042. For example, present systems utilize 60 gallons of water per minute for injection from the cleaning head 1014. If additional water is available for supply to the cleaning head 1014, a better water injection system and cleaning system can be provided. When cleaning a fully charged sewer, i.e., sewer capacity at maximum, the decanted water may be disposed of in a downstream sewer.

Referring now to FIG. 16, the system comprises a truck-mounted high pressure water pump assembly 1110 for generating high pressure water, a high pressure water hose 1112, a hose reel 1113, a cleaning head 1114 for receiving high pressure water and cleaning a sewer, a vacuum system comprising a vacuum tube 1118 held in place by a boom 1119, an air pump 1150 used to create the vacuum, generally located at or near a silencer 1151 and a discharge point 1152 where air is released to the atmosphere. The system further comprises a waste container 1120 for receiving the pumped slurry, a main supply water line 1132, and a main supply water source 1134. The boom 1119 may be used to control the position of various devices and the movement of a pressure water hose 1112 to inject pressurized water through the waste collection system.

The high pressure water pump assembly 1110 is mounted on, for example, a truck 1140. The purpose of the pump assembly 1110 is to pressurize water for use in washing sewer lines 1142 by means of cleaning head 1114 attached to and in communication with high pressure water hose 1112. The source of water for the pump assembly 1110 may be derived from any water source 1134, including a fire hydrant, a tank on the truck 1140, or from the sewer itself. The pump assembly 1110 may be equivalent to the pump assembly 1010 as described above.

The cleaning head 1114 may be bullet-shaped with a front and rear face. The rear face of the cleaning head 1114 has water jet outlets directed backwardly. The truck 1140, high pressure water hose 1112 and cleaning head 1114 may be of any suitable conventional equipment. When the cleaning head 1114 is lowered through a manhole 1141, and into a sewer 1142, high pressure water, such as 2000 psi is applied through the hose 1112 to the cleaning head 1114. The high pressure water applied to the cleaning head 1114 has several functions. First, the water sprays out of the outlets and the exiting high pressure water washes the solid material from the walls of the sewer 1142 and suspends the sewer pipe solid material in a slurry. Additionally, the high pressure water being applied to the cleaning head 1114 moves the cleaning head 1114 in a direction 1143. After cleaning the sewer 1142, the cleaning head 1114 may be retrieved by retracting the high pressure water hose 1112 by means of the hose reel 1113.

If conditions dictate that a vacuum system be used, i.e., if a relatively small volume of liquid exists in the sewer 1142, a vacuum system comprising a vacuum tube 1118 held in place by a boom 1119, an air pump 1150, generally located at or near a silencer 1151 and a discharge point 1152 where air is released to the atmosphere, is provided. The air pump 1150 creates a negative pressure in the system, causing slurry to be sucked up through the vacuum tube 1118 and into the waste container 1120. The solid material in the waste slurry then falls to the bottom of the waste container 1120. The air pump 1150 continues to pull the air in the container 1120 through the air pump 1150, and through the silencer 1151 before being released to the atmosphere through the discharge point 1152.

Use of a submersible pump allows for decanting of water simultaneously while performing the cleaning operation. This may not be possible with a vacuum system. However, because a submersible pump cannot be used effectively when little or no water exists in the pipe to be cleaned, the vacuum system is necessary to deal with these types of situations. In these embodiments, the submersible pump may not be capable of use when the vacuum system is in operation or it may be capable of use simultaneously with the vacuum system. Similarly, the vacuum system may not be capable of being used simultaneously with the submersible pump or it may be capable of being used simultaneously.

Loosening solid materials, i.e. debris, mud, etc. from the walls of the waste collection system and getting the solid materials to the submersible pump 1016 requires a high pressure stream of water. A pressurized water pumping system as described above is not always available or practical for cleaning the waste collection system.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method for mapping and cleaning sediment in a submerged structure of a water storage or treatment facility, the method comprising:
identifying a suitable structure;
conducting a pre-survey site inspection;
collecting water chemistry data;
analyzing the water chemistry data;
conducting a pre-cleaning acoustic survey;
mapping the sediment elevation;
creating a floor sediment elevation map;
collecting sediment samples;
analyzing the sediment samples;
generating a sediment report;
calculating sediment volumes and weight;
cleaning the structure;
separating grit from water;
conducting a post-cleaning acoustic survey;
re-mapping the sediment elevation;
calculating the volume of removed sediment; and
generating a tank cleaning report.

18. The method of claim 17, wherein the pre-cleaning acoustic survey and the post-cleaning acoustic survey are compared in the tank cleaning report to determine sufficiency of cleaning.

19. The method of claim 17, wherein the mapping the sediment elevation and the re-mapping the sediment elevation are compared in the tank cleaning report to determine sufficiency of cleaning.

20. The method of claim 17, wherein the calculated sediment volumes and weight and the calculated volume of removed sediment are compared in the tank cleaning report to determine sufficiency of cleaning.
